(19) United States
(12) Patent Application Publication
(10) Pub. No.: US 2023/0262853 A1
(43) Pub. Date: Aug. 17, 2023

(54) DEVICE FOR HEATING A MATERIAL USING MICROWAVES, METHOD FOR HEATING A MATERIAL USING MICROWAVES, AND SYSTEMS FOR HEATING A MATERIAL USING MICROWAVES

(71) Applicant: VALE S.A., Rio de Janeiro (BR)

(72) Inventors: Mauro Fumio YAMAMOTO, Rio de Janeiro (BR); Pedro Porto Silva CAVALCANTI, Rio de Janeiro (BR); Fernando Oliveira BOECHAT, Vila Velha (BR); Reginaldo Elias da SILVA, Petrópolis (BR); Leonardo Rodrigues VENTURA, Barra Mansa (BR); Leonardo Batista de Almeida SCARABELLI, Petrópolis (BR); Edvandro Rezende Rodrigues JÚNIOR, Duque de Caxias (BR); Thailli CONTE, Rio deJaneiro (BR)

(21) Appl. No.: 18/010,755

(22) PCT Filed: Jun. 16, 2021
(86) PCT No.: PCT/BR2021/050262

§ 371 Date: Dec. 15, 2022

(30) Foreign Application Priority Data
Jun. 17, 2020 (BR) 102020012185-5
Mar. 8, 2021 (BR) 132021004301-5

(51) Int. Cl. H05B 6/78

(52) U.S. Cl. CPC H05B 6/78

(57) ABSTRACT

The present invention relates to a device for heating materials using microwaves, particularly applicable to the heating of ore products, which makes it possible to eliminate the use of fossil fuels (for example natural gas, coal, fuel oil, etc.) for generating heat for heating this type of material, rendering viable the use of microwaves for heating materials through a more efficient dispersion of the electromagnetic waves thereof. The present invention also relates to systems that make use of the heating device as set out above, and a method for heating using microwaves.

The present invention refers to a device for microwave material heating, particularly applicable to the heating of ore products, which allows eliminating the use of fossil fuels (e.g., natural gas, coal, heavy oil etc.) for the generation of heat for heating this type of material, enabling the use of microwaves for heating materials through more efficient dispersion of its electromagnetic waves.

The present invention also relates to a system that uses a heating chamber and a microwave heating method.

### DESCRIPTION OF THE STATE OF THE ART

The process of reducing the moisture of a mining product by heating, in many cases, is highly harmful to the environment since it requires the use of fossil fuel-based fuels (e.g., natural gas, coal, heavy oil etc.) due to the way it is exploited by the mining industry today.

To reduce the environmental impacts caused by the use of such technology of CO₂ emission, the development of alternative methods of reducing the moisture of the mining product has been encouraged.

Among the solutions proposed in the state of the art, the use of microwave radiation systems to reduce the moisture of mining products has aroused interest in different sectors of the mining industry.

However, performance-related problems imply large-scale implementation and operation costs for this type of solution and prevent its use from becoming more economically advantageous. For example, in a simpler solution, in which the mining product is heated by being subjected only to electromagnetic waves, the time required for heating the product and the cost of the equipment are factors that hinder the large-scale use of the technology. That is because, after studies and analyses conducted on the energy use of these devices, it could be observed that the electromagnetic waves are not adequately dispersed in the regions of interest of the ore products.

It could be observed that the heating is performed very heterogeneously, which significantly impairs the efficiency of the heating process of the material. Ideally, heating should be more evenly distributed over the entire surface of the material. Instead, the lack of dispersion in the state-of-the-art drying devices implies a longer exposure time to achieve appropriate drying of the product, and it makes the process inefficient and non-competitive in operational costs.

That occurs primarily because of an inherent design flaw in the state-of-the-art microwave heaters. When using a single chamber with multiple wave-emitting sources, an electromagnetic wave from a first source may enter the output of a second source, potentially burning out its magnetron. To avoid this situation, it is necessary to use a greater distance between the sources by increasing the size of the chamber, which, in turn, decreases the power x area ratio (kW/m²). Moreover, the emission of electromagnetic waves directly into the empty space inside the chamber does not allow an appropriate reflection and dispersion of these waves for homogeneous heating of the material of interest, further decreasing the device's efficiency.

State of the art brings some possibilities for the construction of microwave heating chambers, as seen in the US patent document U.S. Pat. No. 4,870,236. This document proposes a chamber for microwave heating of materials that uses at least a pair of cavities in which the electromagnetic wave source is arranged. The waves are reflected inside the waveguide to eventually reach the main chamber where the materials to be heated are located. However, this solution shown in U.S. Pat. No. 4,870,236 does not solve the problem of inefficient dispersion of the electromagnetic waves because the waves are distributed uncontrollably after their arrival in the chamber, resulting in the same heterogeneous dispersion observed in other state-of-the-art chambers.

Therefore, no microwave heating device can adequately disperse the electromagnetic waves in the state of the art, resulting in efficient heating of the mining product and allowing the elimination of the use of environmentally harmful combustion heat generation systems as well as a reduction of electric power and fossil fuels.

### OBJECTIVES OF THE INVENTION

Objective one of the present invention is to provide a microwave heating device that can replace and entirely or partially eliminate the need for using fuel-burning systems to obtain heat.

Objective two of the present invention is to provide a microwave heating device that allows efficient, homogeneous dispersion of the electromagnetic waves over the product to be heated.

Objective three of the present invention is to provide a microwave heating device comprising a wall shape conducive to the dispersion of electromagnetic waves efficiently over the product to be heated.

Objective four of the present invention is to provide a microwave heating system that uses the aforementioned heating device to enable efficient, serial heating of the material of interest.

Objective five of the present invention is to provide a microwave heating method that uses the abovementioned heating device.

Objective six of the present invention is to provide a microwave heating device and system that prevents microwave leakage to the external environment, ensuring the safety of operators in the surroundings.

Objective seven of the present invention is to provide a microwave heating device and system that prevents vapors and particulates from the material under drying from entering the heating device.

### BRIEF DESCRIPTION OF THE INVENTION

In a first implementation, the present invention device comprises a main cavity defining an inner portion and an outer portion of the device, the main cavity being provided with at least one wall and being configured to receive at least one electromagnetic wave emission source, at least one wall of the main cavity comprising at least one portion bent at an acute angle formed against a vertical reference centerline of the main cavity.

In one possible configuration, the angle of inclination of the sloping portion of the main cavity wall is between 15° and 40°.

In another possible configuration, the device comprises at least one auxiliary cavity, arranged inside the main cavity and between the source and the outer portion, the auxiliary cavity enclosing an auxiliary reflection region of at least part of the electromagnetic waves generated by the source.

In another possible configuration, the auxiliary cavity has a rectangular cross-sectional profile, walls of which project from a pair of housing side walls, parallel to a vertical reference centerline of the cavity and in the direction of the outer portion.

In another possible configuration, at least one wall of the main cavity contains a permanent magnet element.

The present invention further addresses a device for microwave material heating, comprising a main cavity, defining an inner portion and an outer portion of the device, the main cavity being provided with at least one wall, the main cavity being configured to receive at least one source of electromagnetic wave emission, where, in at least one wall of the main cavity, a permanent magnet element is arranged.

The present invention further refers to a method of microwave material heating that uses a device comprising a main cavity defining an inner portion and an outer portion of the device, the main cavity being provided with at least one wall, the main cavity being configured to receive at least one source of electromagnetic wave emission, the method comprising the stage of:
reflecting at least part of the electromagnetic waves emitted by the source on at least a portion of the wall bent at an acute angle formed against a vertical reference centerline of the main cavity.

In one possible configuration, the method comprises at least one of the stages of:
reflecting at least part of the electromagnetic waves emitted by the source in at least a portion of an auxiliary cavity arranged inside the main cavity and in between the source and the outer portion; and
changing the course of at least part of the electromagnetic waves emitted by the source through a permanent magnet element arranged in at least one wall of the main cavity.

The present invention further addresses a system for microwave material heating comprising a conveyor of material to be heated and a material feeding zone on the conveyor, the system comprising a material heating zone, the material feeding zone being arranged prior to the material heating zone, the material heating zone comprising at least one microwave heating device such as the aforementioned.

In one possible implementation, the system comprises dielectric material plates arranged on the conveyor and a plate heating zone, the material feeding zone being arranged in between the plate heating zone and the material heating zone, the plate heating zone comprising at least one microwave heating device such as the one above.

The present invention further addresses a system for microwave material heating comprising at least one device for microwave material heating, such as the aforementioned, and at least one microwave containment housing surrounding at least one device.

In one possible implementation, the system comprises a conveyor of a material to be heated and a material feeding zone over the conveyor, the system comprising a material heating zone, the material feeding zone being arranged before the material heating zone, the material heating zone comprising at least one microwave heating chamber, comprising at least one microwave heating device.

In another possible implementation, at least one microwave containment housing is arranged around at least one microwave heating chamber.

In another possible implementation, at least one microwave containment housing is a Faraday cage.

In another possible implementation, at least one microwave containment housing extends over at least a portion of a belt conveyor.

In another possible implementation, the system additionally comprises at least one sealing plate adapted for sealing a lower opening of the main cavity.

In another possible implementation, at least one sealing plate is a Teflon plate.

### SUMMARY DESCRIPTION OF THE DRAWINGS

The present invention will be further described below based on an example of execution represented in the drawings.

The figures show:

FIG. 1—a side view of a state-of-the-art microwave material heating chamber without cavities;

FIG. 2—a top view of a state-of-the-art microwave material heating chamber without cavities;

FIG. 3—a picture of the lower region of a state-of-the-art microwave material heating chamber separated into two cavities by a wall, including a picture of the temperature gradient of the heated surface;

FIG. 4—a side view of a completely rectangular state-of-the-art cavity;

FIG. 5—a top view of a completely rectangular state-of-the-art cavity;

FIG. 6—a side view of a state-of-the-art microwave material heating chamber with completely rectangular cavities;

FIG. 7—a schematic representation of the electromagnetic wave behavior in a portion of the state-of-the-art microwave material heating chamber with completely rectangular cavities, including a temperature gradient image of the heated surface;

FIG. 8—a side view of a first implementation of the present invention device;

FIG. 9—a top view of a first implementation of the present invention device;

FIG. 10—an image of the temperature gradient of the heated surface when using the present invention device in its first implementation;

FIG. 11—a side view of a second implementation of the present invention device;

FIG. 12—a top view of a second implementation of the present invention device;

FIG. 13—a schematic representation of the electromagnetic wave behavior when using the present invention device in its second implementation, including a temperature gradient image of the heated surface;

FIG. 14—a side view of the heating chamber of the present invention in a preferred configuration;

FIG. 15—a side view of the heating system of the present invention in a preferred configuration; and

FIG. 16—details the side view of the heating system of the present invention in a preferred configuration.

FIG. 17—illustrates an isometric view of the heating system of the present invention in a preferred configuration applied to a belt conveyor.

FIG. 18—illustrates a front view of the heating system of the present invention in a preferred configuration applied to a belt conveyor.

FIG. 19—illustrates a side view of the heating system of the present invention comprising a microwave containment housing.

FIG. 20—illustrates a front view of the heating system of the present invention comprising a microwave containment housing.

FIG. 21—illustrates a side view of an alternative implementation of the present invention device comprising a sealing plate.

### DETAILED DESCRIPTION OF THE FIGURES

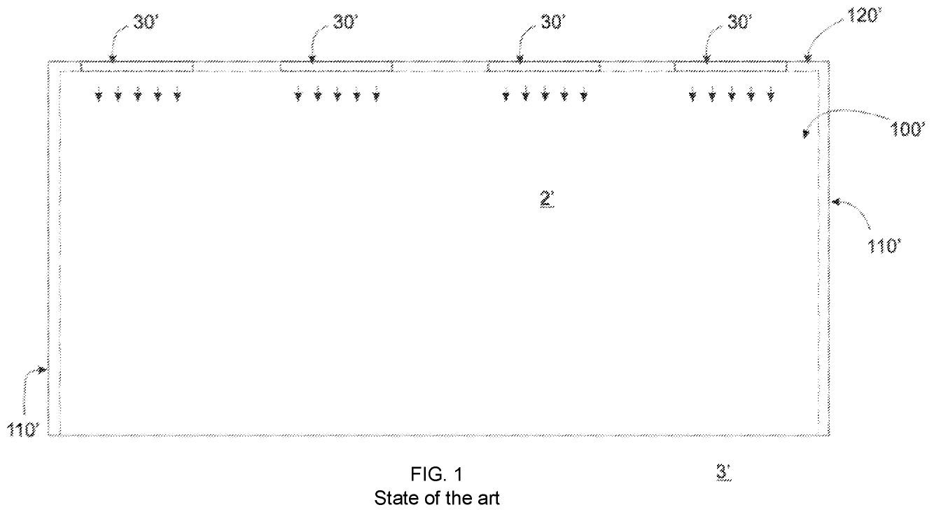

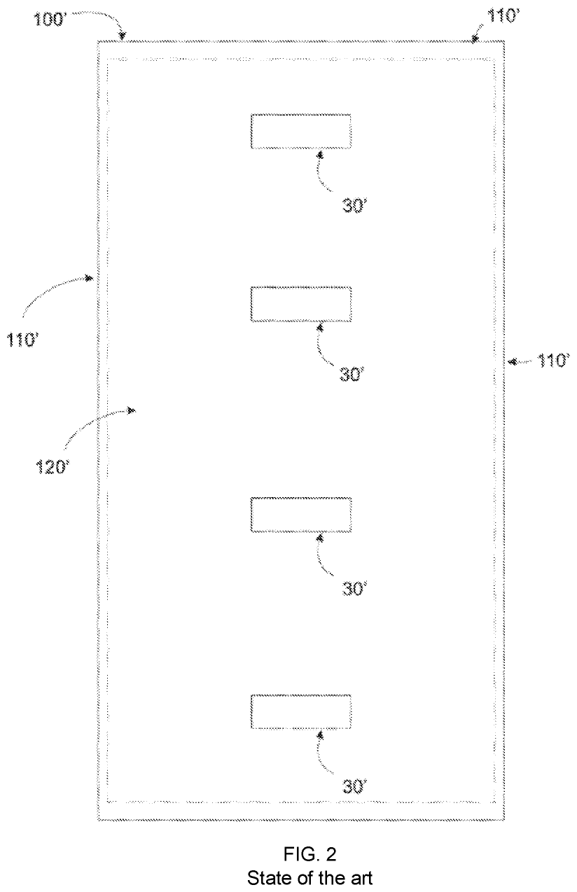

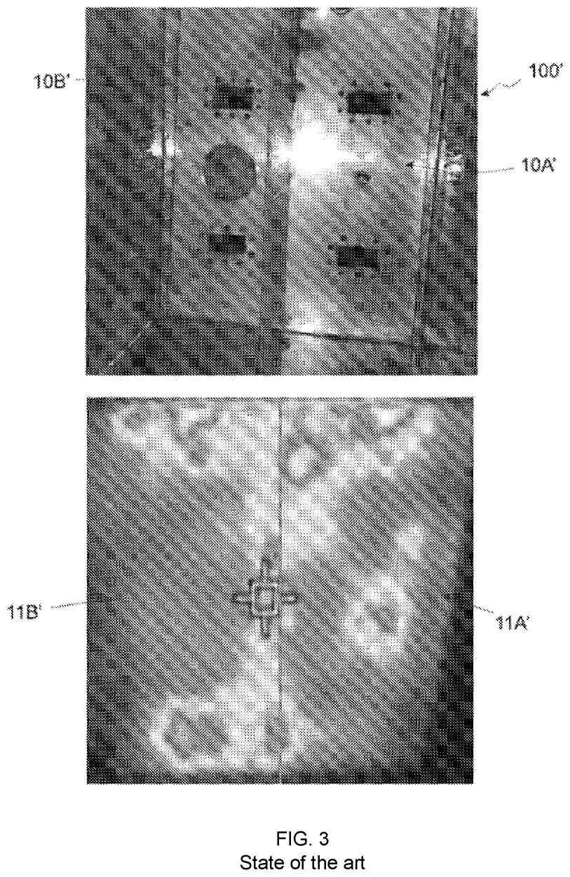

FIGS. 1 and 2 show a state-of-the-art microwave material heating chamber 100′. This chamber 100′ comprises side walls 110′ and an upper wall 120′, forming a simple rectangle with an inner 2′ and outer 3′ portion, the inner 2′ portion housing multiple sources 30′ emitting electromagnetic waves which heat the material arranged below the chamber 100′ in its outer 3′ portion. FIG. 3 shows an image of the lower region of a state-of-the-art microwave material heating chamber 100′ separated into two cavities 10A′, 10B′ by a wall, including a temperature gradient image of the heated surface corresponding to both sides 11A′, 11B′ of the chamber.

In this implementation of FIGS. 1 to 2, it can be observed that no cavity of any kind is used, which exposes the sources 30′ to each other's electromagnetic waves and can generate the burning of their magnetrons. As it has already been explained, to avoid this burning, the 30′ sources of this prior implementation need to be spaced a great distance apart from each other, which decreases the power x area ratio (kW/m²) and impairs the correct dispersion of the electromagnetic waves, as it can be better seen in FIG. 3. In a brief comparison, state-of-the-art 100′ heating chambers use distances between sources three to four times greater than those allowed by the present invention, as it will become clear below. Even if a wall is used to separate the cavities, as seen in FIG. 3, the result is unsatisfactory.

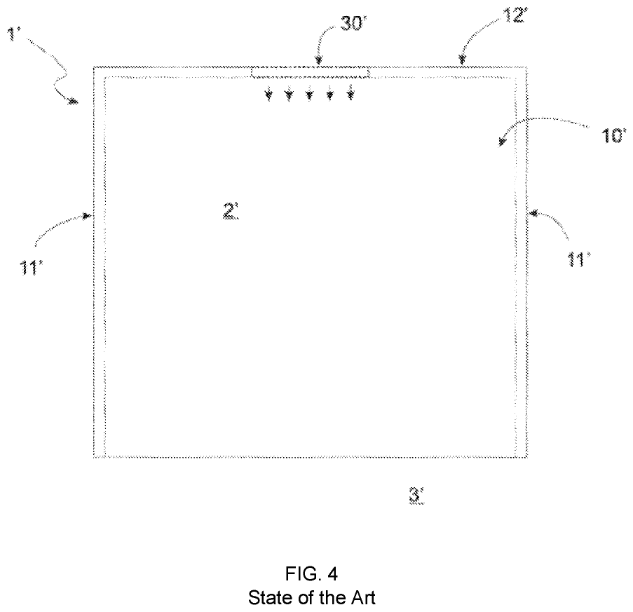

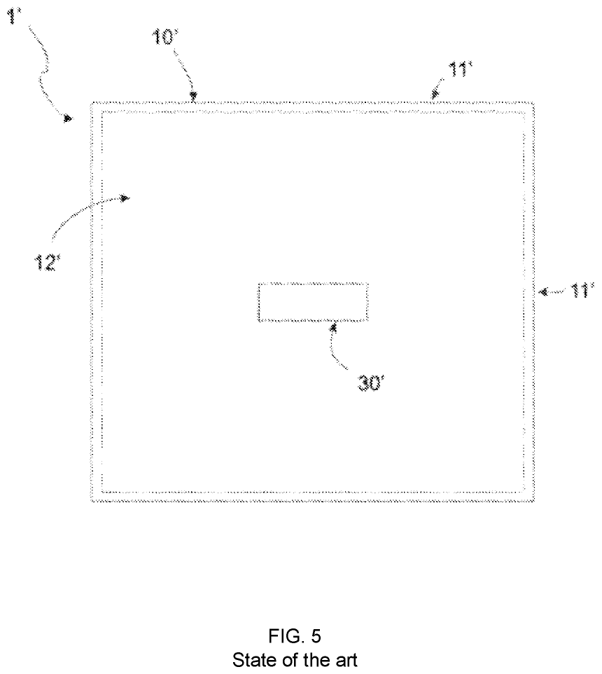

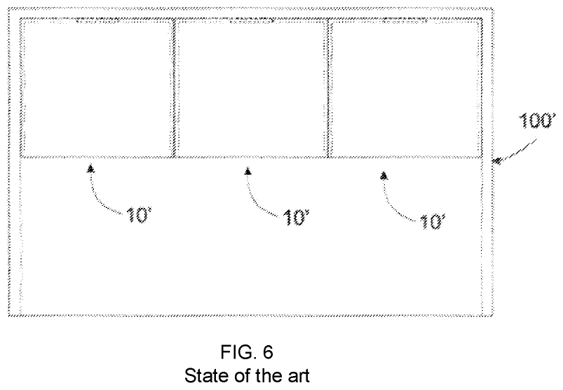

FIGS. 4 to 7 show a state-of-the-art 10′ cavity, and FIG. 6 represents this 10′ cavity applied to a state-of-the-art 100′ chamber. It can be seen that this previous realization tries to eliminate the possibility of burning of the 30′ sources by their insertion in 10′ cavities, as well as tries to direct the electromagnetic waves derived from the 30′ source to the material to be heated.

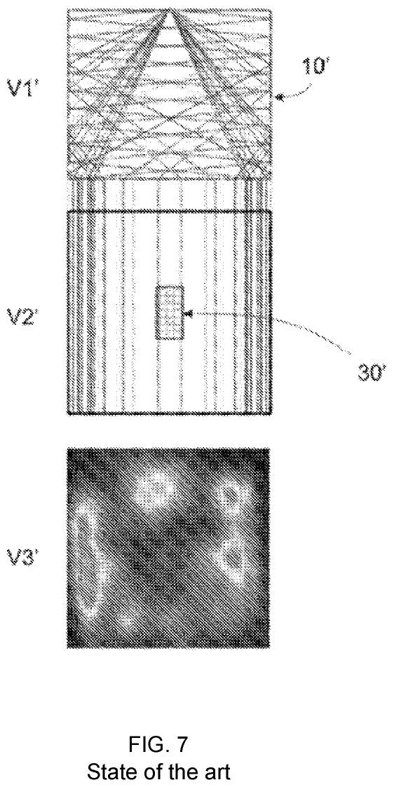

However, FIG. 7 shows a schematic representation of tests performed on these 10′ state-of-the-art microwave heating cavities, where V1′ is a side view of the device showing the wave lines reflected on the surface of its structure, V2′ is a top view of the device for reference, and V3′ is an image showing the temperature gradient of the heated surface, where the warmer colors represent higher temperature and the colder ones, lower temperature. Again, it was noted that the heating is performed heterogeneously and the center of the surface appreciates almost no heating, which proves the lack of efficiency in the dispersion of the waves even making use of this type of cavity 10′.

Thus, the state of the art cannot offer a device, chamber, or system for microwave material heating that is efficient enough to replace the use of fuel-burning heat generation.

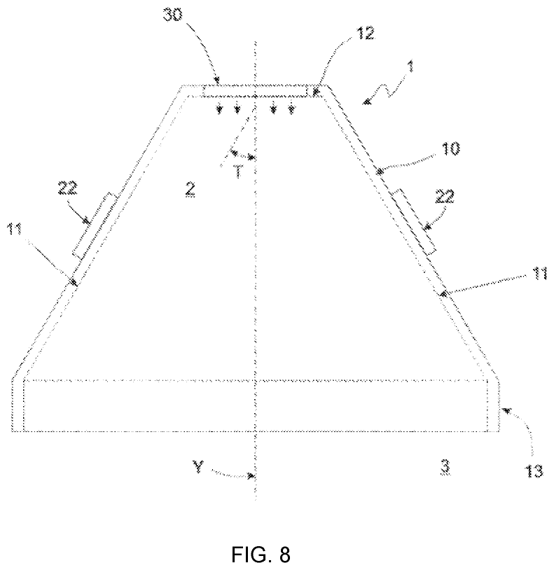

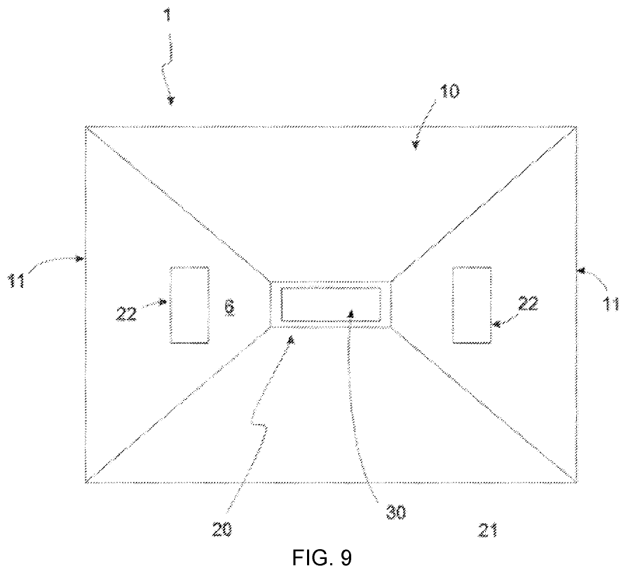

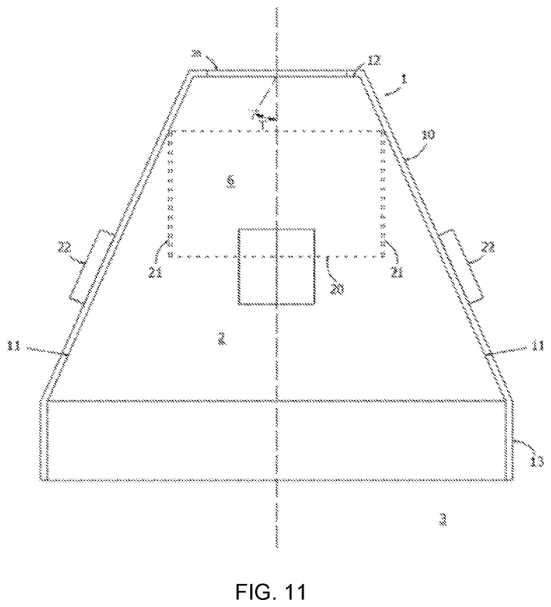

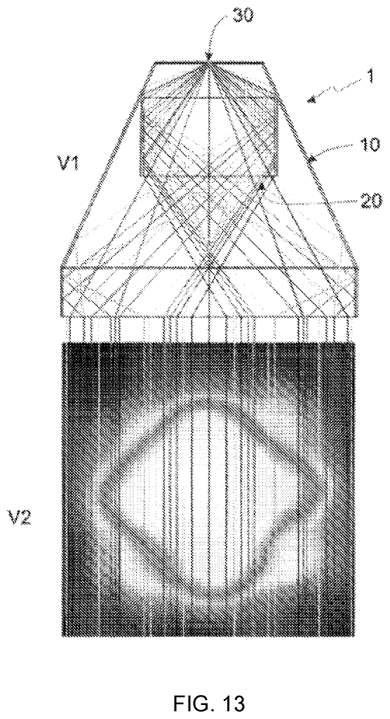

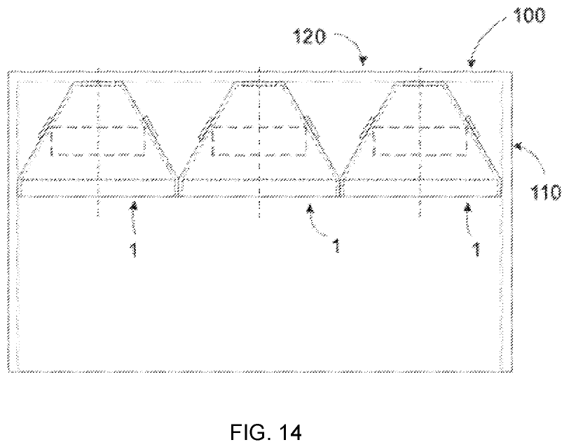

To solve this problem, the present invention device 1 is provided in a first implementation shown in FIGS. 8 to 10; in a second implementation shown in FIGS. 11 and 13, a chamber 100 that uses these implementations of device 1 in FIG. 14, and a system 200 that uses chamber 100.

In a first implementation of the present invention device 1 shown in FIGS. 8 to 10, it is provided a device 1 with a cavity 10 of which wall shape is conducive to the dispersion of electromagnetic waves efficiently on the product to be heated.

More specifically, the device 1 in its first implementation comprises a main cavity 10, defining an inner portion 2 and an outer portion 3 of the device 1 and being provided with at least one wall 11. The main cavity 10 is configured to receive at least one electromagnetic wave emission source 30, which preferably emits electromagnetic waves with a wavelength between 122 mm and 328 mm and a frequency in the range between 2450 and 915 MHz, and this range may change substantially depending on the desired application.

In this first implementation, at least one wall 11 of the main cavity 10 comprises at least one portion bent at an acute angle T formed against a reference vertical centerline Y of the main cavity 1. The housing further preferably comprises an upper wall 12 housing the source 30, more preferably arranged perpendicularly to the centerline Y.

The centerline Y is an imaginary guiding line that cuts vertically through the housing 10 from its center in a side view in a mirrored bipartite arrangement. Each side wall 11 projects at an acute angle T against this centerline Y in a direction away from the centerline Y, so that the housing 10 configures a substantially conical or “bi-pyramidal horn” shaped form. The angle T is preferably between 15° and 40°, more preferably between 20° and 30°, and more referentially 28°. More preferably, the present invention device 1 may comprise two pairs of side walls 11 arranged perpendicularly to each other two by two, configuring a substantially pyramidal shape.

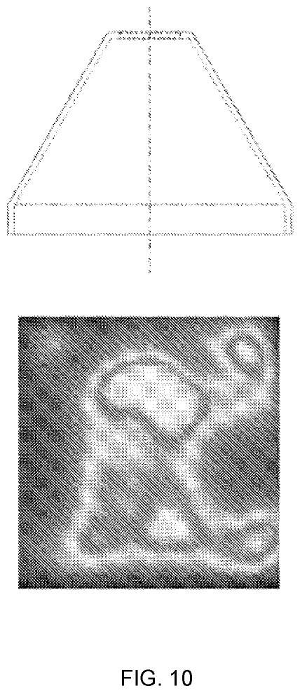

The use of a main cavity 10 provided with a side wall 11 having an acute angle T of inclination allows a more efficient reflection of the electromagnetic waves emitted by the source 30 in the direction of dispersion of the waves onto the material to be heated. In this way, a homogeneous temperature gradient is obtained, as seen in FIG. 10.

In this way, a more efficient dispersion level than that seen in state-of-the-art chambers and cavities is obtained through this first implementation, increasing the power x area ratio (kW/m²) and making its application feasible, for example, in the field of ore product heating, which becomes clear by simple comparison between FIG. 3 or 7 and FIG. 10.

In agreement with this first implementation of device 1, a microwave material heating method is further provided that comprises the stage of:
reflecting at least part of the electromagnetic waves emitted by the source 30 on at least a portion of the wall 11 bent at an acute angle T formed against a reference vertical centerline Y of the main cavity 1.

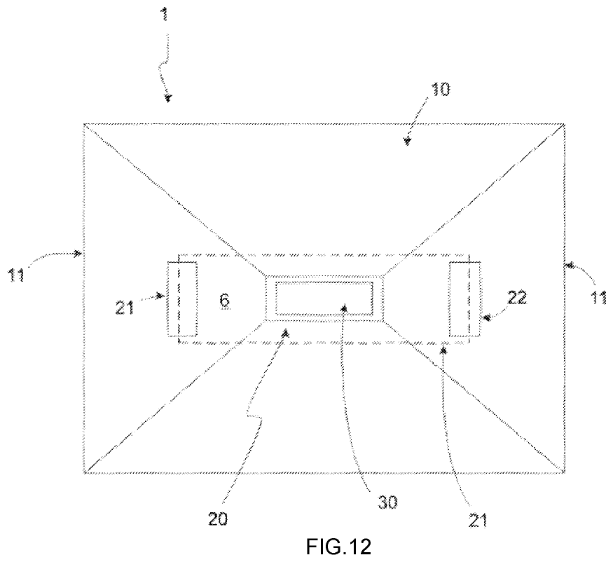

A second implementation of the present invention can be seen in FIGS. 11 to 13, wherein using a main cavity and an auxiliary cavity for the dispersion of electromagnetic waves in an efficient manner One has in this second implementation a main cavity 10 defining an inner portion 2 and an outer portion 3 of the device 1, the main cavity 10 is configured to receive at least one source 30 of electromagnetic wave emission, as is also seen in the first implementation.

In this second implementation, the device 1 comprises at least one auxiliary cavity 20 arranged inside the main cavity 10 and in the intermediate between the source 30 and the outer portion 3. The auxiliary cavity 20 boundaries an auxiliary region 6 for reflection of at least part of the electromagnetic waves generated by the source 30 to allow further reflection of said waves and to ensure greater dispersion of said waves on the material to be heated.

The auxiliary cavity 20 preferably comprises a rectangular cross-sectional profile of which walls 21 project from a pair of side walls 11 of the housing, parallel to a vertical centerline Y of reference of the cavity 10 and in the direction of the outer portion 3, configuring a substantially “cube” or “box” shape. The side walls 11 of the housing may be angled or not angled, configuring a “bi-pyramidal horn” shape or still others, such as simply rectangular or square.

The upper and lower surfaces of the auxiliary cavity 20 are open to pass the electromagnetic waves provided by the source 30. Other cross-sectional profiles may be used for the construction of the auxiliary cavity 20, depending, for example, on the shape of the main cavity 10, the type of material to be heated, or the desired application.

The auxiliary region 6 for reflecting electromagnetic waves is bounded by the walls of chamber 20 and by its upper and lower apertures. Such a region 6 is intended to reflect the electromagnetic waves in a pattern that disperses them into a region of interest. In this way, a homogeneous heating of the material is obtained.

In agreement with the second implementation of device 1 disclosed above, a method is provided for microwave heating of material comprising the stage of:
reflecting at least part of the electromagnetic waves emitted by the source 30 in at least a portion of an auxiliary cavity 20 arranged inside the main cavity 10 and between the source 30 and the outer portion 3.

Having presented the first and second implementations of the present invention device 1, a third possible implementation involves joining the first and second implementations to obtain a device 1 of particular efficiency, thereby joining the wall shape 11 and auxiliary cavity 20 features to promote even more homogeneous and efficient dispersion of electromagnetic waves.

FIGS. 11 to 13 show this third implementation, providing for the use of walls 11 provided with an angle T against the reference vertical axis Y, as well as the existence of an auxiliary cavity 20 inside the main cavity 10. The effects of this third implementation can be observed in FIG. 13, which shows the temperature gradient in a product heated by the device 10 of FIGS. 11 to 13. More specifically, FIG. 13 discloses images V1 and V2, where V1 is a side view of the present invention device 1 showing the wave lines reflected on the surface of its main cavity 10 and its auxiliary cavity 20, and V2 is an image showing the temperature gradient of the surface heated by the present invention device 1, where warmer colors represent higher temperature and cooler colors represent lower temperature. An advantageously homogeneous heating result is noted, proving the appropriate efficiency of this third implementation in heating materials by microwave, and proving to be a viable alternative to heating by burning fuel.

In agreement with this third implementation of the present invention, it is explained that the methods tied to the first and second implementations can be united into a single method for particularly efficient microwave material heating, which comprises the stage of:
reflecting at least part of the electromagnetic waves emitted by the source 30 on at least a portion of the wall 11 bent at an acute angle T formed against a reference vertical centerline Y of the main cavity 1; and
reflecting at least part of the electromagnetic waves emitted by the source 30 in at least a portion of an auxiliary cavity 20 arranged inside the main cavity 10 and between the source 30 and the outer portion 3.

After presenting these three possible implementations of the present invention device 1, features of the device 1 that can be applied to any of the implementations are presented below, on an optional basis, to obtain different beneficial effects in its functionality and use.

Optionally and applicable in any of the aforementioned implementations, the device 1 may comprise, in at least one wall of the main cavity 10, a permanent magnet element 22, for example, comprising ferrite or neodymium. This magnet 22 is intended to change the course of at least part of the electromagnetic waves, specifically the magnetic waves, emitted by the source 30, to complement the dispersion of the waves on the product of interest. The magnet 22 may be, for example, arranged on the bent portions of the walls 11 of the device 1, and at different heights to obtain different electromagnetic wave course change effects depending on the desired application.

To better understand the effects of including the magnet in the present invention device 1, it can be explained that electromagnetic waves are composed of electric and magnetic waves, which propagate orthogonally. When the magnet is applied to the present invention device 1, the north pole magnetic wave is attracted by the south pole magnet, to the direction of the wall, reflecting and changing the path of the magnetic wave. The north pole magnet attracts the south pole wave, reflecting and changing the trajectory of the magnetic wave.

Accordingly, any of the aforementioned methods may further comprise a stage of:
changing the course of at least part of the electromagnetic waves emitted by the source 30 through a permanent magnet element 22 arranged on at least one wall of the main cavity 10.

In each implementation, the device 1 mentioned herein may also comprise a projection 13 arranged on the lower portion of its wall or walls 11 and preferably projected parallel to the vertical reference line Y, more preferably enveloping the entire perimeter of the main cavity 10, such as a “skirt.” This projection 13 is intended to prevent electromagnetic waves from exiting externally to the perimeter of the cavity.

Therefore, the present invention device 1, in its implementations shown herein, is capable of efficiently dispersing the electromagnetic waves emitted by the source 30, either by their reflection from the inclined walls of the main cavity 10, or by their reflection in the auxiliary cavity 20, thus allowing homogeneous heating of the material of interest and ensuring the feasibility of using electromagnetic waves for heating/drying products. Particularly, the present invention device 1 is advantageously applicable to chambers for heating/drying of ore products since they allow to replace the use of heat generators by burning fuels such as coal, natural gas, and heavy oil, bringing relevant advantages from the ecological point of view.

Accordingly, the present invention also refers to a chamber 100 for microwave material heating by comprising a device such as the aforementioned in any of its implementations. As seen in FIG. 14, the chamber 100 may, for example, comprise side walls 110 and an upper wall 120, with the lower portion open to pass the electromagnetic waves. Inside the walls 110, 120, there is at least one device 1 such as the aforementioned in any of its implementations, and preferably multiple devices 1 arranged in series. The number of devices 1 inserted in the chamber 100 depends on different factors such as the material to be heated, the required final heating temperature of the product, etc.

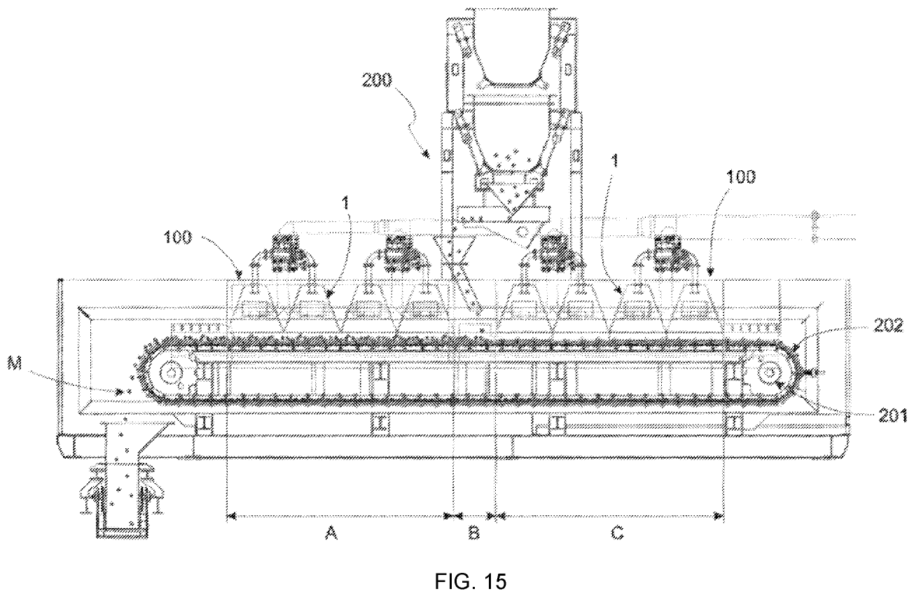

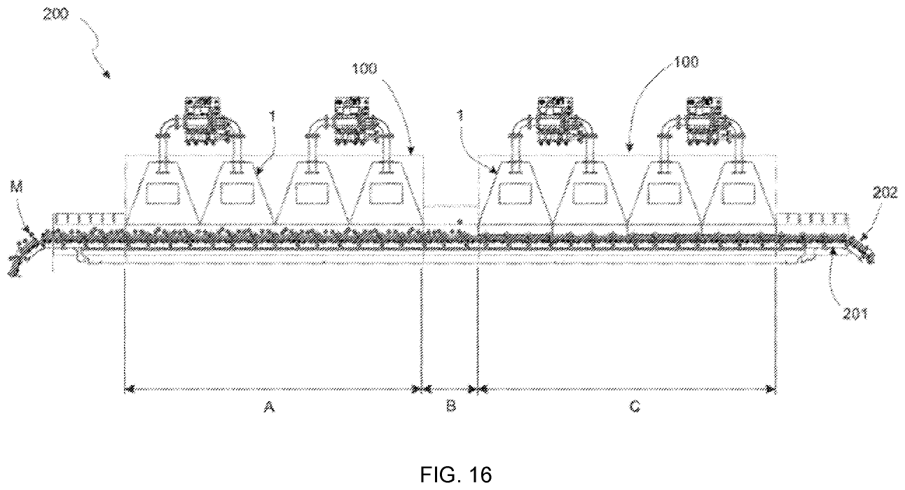

Additionally, the present invention also refers to a system 200 for microwave material heating that comprises a chamber 100, such as the aforementioned. The system 200 is illustrated in a preferred, but not mandatory, the configuration in FIGS. 15 and 16, wherein it can be seen that the same comprises a conveyor 201 of M material to be heated and a material feed zone B over the conveyor 201. The system further comprises a material heating zone A, wherein the material feeding zone B is arranged prior to the material heating zone A, wherein the material heating zone A comprising at least one chamber 100, such as the aforementioned.

Optionally, the system 200 comprises dielectric material plates 202 (i.e., material plates with a high dielectric property) arranged on the conveyor 201 and a plate heating zone C, wherein the material feed zone B is arranged in the intermediate between the plate heating zone C and the material heating zone A. Further, the plate heating zone C comprises at least one chamber 100, such as the aforementioned.

Preferably, but not necessarily, the conveyor 201 is a grid conveyor, and the dielectric material plate 202 is composed of refractory material with high dielectric property, which may be, for example, silicon carbide, manganese dioxide (MnO₂) or (CaMn₇O₁₂) compounds, or barium titanate.

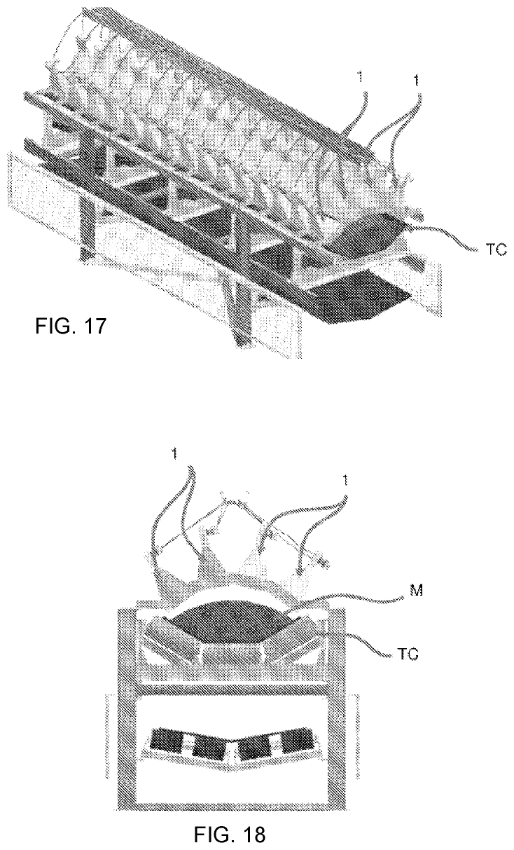

In a possible implementation of the system of the present invention, the same may be employed on a belt conveyor TC, as illustrated in FIGS. 17 to 20. The belt conveyor, where the system of the present invention is applied, may have, for example, a long length. In such implementation, a plurality of devices 1 may be employed along the belt conveyor. Such an implementation may be employed, for example, for transporting and drying ore over long distances.

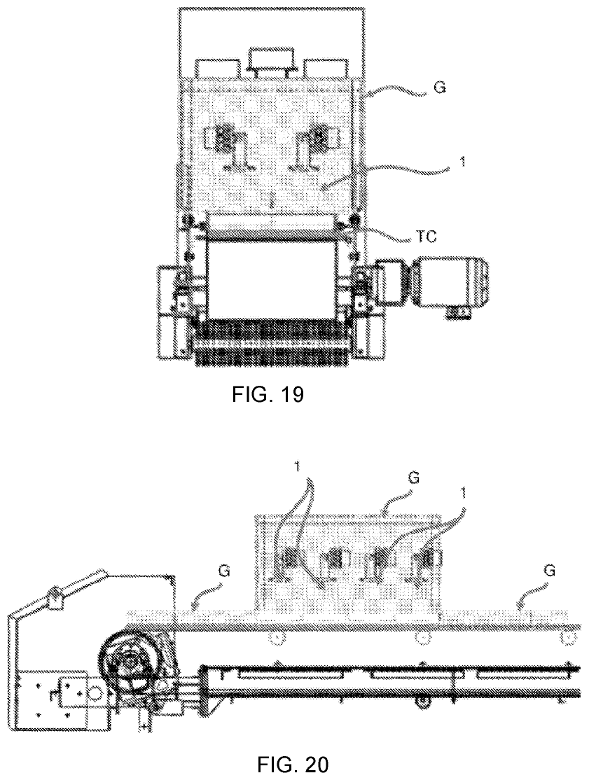

Still referring to the aforementioned implementation, since the belt conveyor may traverse diverse regions where there will not necessarily be a control of the personnel circulating in the surroundings of the heating system, it becomes necessary to implement microwave containment measures to prevent the microwaves from leaving the system and reaching the surrounding personnel. In such a scenario, the present invention's heating system may comprise at least one microwave containment housing G around the devices 1. Preferably, the microwave containment housing G functions as a Faraday cage, as illustrated in FIGS. 19 and 20. Despite the example mentioned herein, the microwave containment housing G is not limited to the Faraday cage, and it is up to a person skilled in the art to replace it with any state-of-the-art element that performs the same function.

Optionally, as shown in FIGS. 19 and 20, at least one microwave containment housing G extends over at least a portion of a belt conveyor TC. More specifically, the microwave containment housing G may extend over the belt conveyor TC downstream and upstream of the device assembly 1, helping to mitigate microwave leakage through the M material inlet and outlet openings of the system.

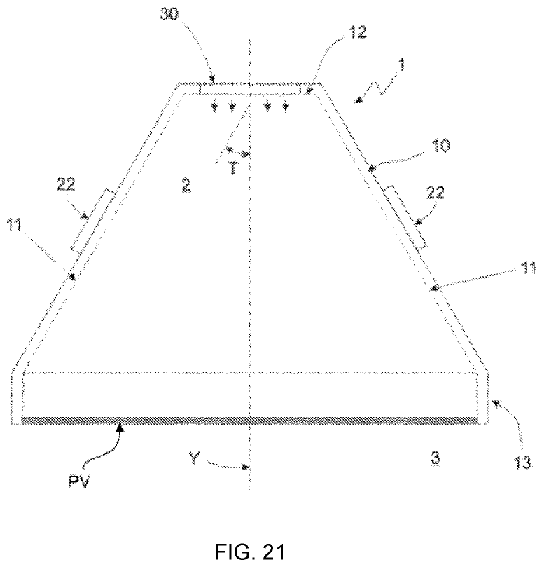

Optionally, as shown in FIG. 21, each device 1 of the present invention comprises at least one PV sealing plate, adapted to seal the bottom opening of the main cavity 10. This way, particulates and vapors from the M material, under heating, are prevented from entering the present invention device 1 and eventually damaging its components. Preferably, the PV sealing plate is manufactured from a material that offers little or no restriction to the passage of microwaves, such as Teflon. Despite the example, the PV seal plate material is not limited to Teflon, and a person skilled in the art shall replace it with any state-of-the-art material that performs the same function.

An example of a preferred implementation having been described, it is to be understood that the scope of the present invention covers other possible variations and is limited only by the content of the appended claims, therein including possible equivalents.

1. A device for microwave material heating by comprising a main cavity defining an inner portion and an outer portion of the device, the main cavity being provided with at least one wall, the main cavity being configured to receive at least one source of electromagnetic wave emission, in which at least one wall of the main cavity comprises at least one portion bent at an acute angle formed against a vertical centerline of reference of the main cavity, wherein that at least one wall of the main cavity, a permanent magnet element is arranged.

2. The device for microwave material heating according to claim 1, the angle being between 15° e 40°.

3. The device for microwave material heating according to claim 1, further comprising at least one auxiliary cavity arranged inside the main cavity and in between the source and the outer portion, the auxiliary cavity bounding an auxiliary region for reflecting at least part of the electromagnetic waves generated by the source.

4. The device for microwave material heating according to claim 3, wherein the auxiliary cavity has a rectangular cross-sectional profile of which walls project from a pair of side walls of the housing, parallel to a vertical centerline of reference of the cavity and in the direction of the outer portion.

5. (canceled)

6. A method of microwave material heating, the method making use of a device comprising a main cavity defining an inner portion and an outer portion of the device, the main cavity being provided with at least one wall, the main cavity being configured to receive at least one source of electromagnetic wave emission, the method comprising the stage of:
reflecting at least part of the electromagnetic waves emitted by the source on at least a portion of the wall bent at an acute angle formed against a vertical centerline of reference of the main cavity; and
wherein the method comprises the stage of:
changing the course of at least part of the electromagnetic waves emitted by the source through a permanent magnet element arranged in at least one wall of the main cavity.

7. The method of microwave material heating according to claim 6, further comprising the stage of:
reflecting at least part of the electromagnetic waves emitted by the source in at least a portion of an auxiliary cavity arranged inside the main cavity and in between the source and the outer portion.

8. (canceled)

9. A system for material microwave heating, that comprises a conveyor of a material to be heated and a material feed zone on the conveyor, the system further comprising a material heating zone, the material feed zone being arranged before the material heating zone, the material heating zone comprising at least one microwave heating chamber provided with at least one microwave heating device as defined in claim 1.

10. The system for material microwave heating according to claim 9, further comprising plates of dielectric material arranged on the conveyor, the system comprising a plate heating zone, the material feeding zone being arranged in between the plate heating zone and the material heating zone, the plate heating zone comprising at least one microwave heating chamber provided with the at least one microwave heating device.

11. A system for microwave material heating comprising:
at least one device for microwave material heating as defined in claim 1; and
at least one microwave containment housing around at least one device.

12. The system, according to claim 11, further comprising a conveyor of a material to be heated and a material feed zone on the conveyor, the system comprising a material heating zone, the material feed zone being arranged before the material heating zone, the material heating zone comprising at least one microwave heating chamber comprising at least one microwave heating device.

13. The system, according to claim 12, wherein the at least one microwave containment housing is arranged around the at least one microwave heating chamber.

14. The system, according to claim 13, wherein the at least one microwave containment housing being comprises a Faraday cage.

15. The system, according to claim 11, wherein the at least one microwave containment housing extends over at least a portion of a belt conveyor.

16. The system, according to claim 11, further comprising at least one sealing plate adapted to seal a lower opening of the main cavity.

17. The system, according to claim 16, wherein the at least one sealing plate comprises a Teflon plate.
